(19) United States
(12) Patent Application Publication
(10) Pub. No.: US 2015/0364917 A1
(43) Pub. Date: Dec. 17, 2015

(54) SURGE PROTECTION DEVICE FOR PROTECTING AN ON-BOARD POWER SUPPLY SYSTEM OF AN ELECTRIC VEHICLE AGAINST AN ELECTRIC VOLTAGE SURGE AND CORRESPONDING METHOD AND ELECTRIC VEHICLE HAVING THE SURGE PROTECTION DEVICE

(71) Applicant: ROBERT BOSCH GMBH, Stuttgart (DE)

(72) Inventor: Stephan GASE, Tiefenbronn (DE)

(21) Appl. No.: 14/763,563

(22) PCT Filed: Jan. 15, 2014
(86) PCT No.: PCT/EP2014/050682

§ 371 Date: Jul. 27, 2015

(30) Foreign Application Priority Data
Jan. 31, 2013 (DE) 10 2013 201 570.4

(51) Int. Cl. H02H 9/04; H02H 1/04

(52) U.S. Cl. CPC H02H 9/045; H02H 1/04

(57) ABSTRACT

The present invention relates to an overvoltage protection device (100) for protecting an onboard power system (24) of an electric vehicle (20) from electrical overvoltage, having: an input device (105) which is embodied as a power connection of the electric vehicle (20); a protection device (110) which is coupled at an input (110a) to the input device (105) and has at least one overvoltage diverter (111) for diverting an overvoltage; and an interface device (115) which is configured, through coupling of an output (110b) of the protection device (110) to the onboard power system (24), to protect the onboard power system (24) of the electric vehicle (20) from the electrical overvoltage.

### BACKGROUND OF THE INVENTION

The present invention relates to a surge protection device for protecting an on-board power supply system of an electric vehicle against an electric voltage surge and to a corresponding method and to an electric vehicle having the surge protection device.

A socket with a module for additional functions is already known from EP 0 786 833 B1. The additional functions are primarily related to achieving surge protection of consumers which are connected to the socket.

EP 0 786 833 B1 describes a module in the case of which the height of the insulation base must not be changed. The design of a present socket cavity and the design of the components of the module which are to be inserted in said socket cavity are matched to one another in terms of their shape. In the case of the module described in that document, a printed circuit board is provided which runs parallel to the bottom of the present insulation base and which has at least two corners which accommodate surge protection components.

The printed circuit board, in turn, is equipped for electrical connection with resilient contacts, wherein the sockets have blade contacts which produce the necessary electrical connection when the parts are inserted and joined to one another.

A socket, in particular a safety socket with a retrofittable surge protector is already known from German Utility Model DE 295 07 448 U1. The surge protector in that document is designed as a support part with shaped portions for a circuit board, wherein the circuit board bears necessary electrical components. In the case of the safety socket described in that document, the support part has apertures in a bottom section, through which apertures electrical connection lines for the surge protection device run.

DE 20 2008 008 905 U1 describes a surge protection device for insertion, including retrospective insertion, in connection sockets, distribution sockets and/or sockets for flush-mounted fitting or surface installation, wherein the sockets have a fastening plate, also referred to as support ring.

The surge protection device described in that document has a circuit board which accommodates the surge protection elements and a support part with shaped portions for the circuit board and electrical connection means, wherein the support part has an annular-strip-shaped integral extension which surrounds the socket insert in the assembled state.

### SUMMARY OF THE INVENTION

The present invention provides a surge protection device for protecting an on-board power supply system of an electric vehicle against an electric voltage surge.

Accordingly, what is provided is a surge protection device having:
an input device, which is designed as a current connection of the electric vehicle; a protective device, which is coupled to the input device at an input and has at least one surge arrester for diverting a voltage surge; and an interface device, which, owing to a coupling to an output of the protective device and to the on-board power supply system, is configured to protect the on-board power supply system of the electric vehicle against electric voltage surges.

The invention also provides a method for protecting an on-board power supply system of an electric vehicle against an electric voltage surge, according to.

Accordingly, what is provided is a method having the following method steps: coupling an input device of a surge protection device of the electric vehicle to a charging device and coupling a protective device of the surge protection device to the input device via an input of the protective device; providing a surge arrester in the protective device for diverting a voltage surge; and coupling the output of the protective device to the on-board power supply system via an interface device in order to protect the on-board power supply system of the electric vehicle against electric voltage surges.

The present invention also provides an electric vehicle having a surge protection device.

The concept of the invention is that of designing a means for lightning protection and surge protection in an electric vehicle at a point which is downstream of a female charging connector of the electric vehicle.

This advantageously permits destruction of electric components in the on-board power supply system of the electric vehicle by surge-voltage pulses during charging of the vehicle battery to be avoided. The surge protection device can be provided at a central point downstream of the female charging connector in the electric vehicle.

By means of a central surge protector which is connected downstream of the female charging connector in the electric vehicle, the high-voltage electrical components of the on-board power supply system of the electric vehicle can be configured for air gaps and creepage paths according to in each case the optimum surge class.

As a result, installation space and costs can be saved in the case of the on-board electrical power supply system of the electric vehicle since the high-voltage electrical components of the electric vehicle and/or the on-board electrical power supply system itself do not require respectively separate surge protection systems.

According to one embodiment of the invention, provision is made for the input device to be configured to be coupled to a charging device. This enables, in a simple and reliable manner, the electric vehicle to be charged with electrical energy provided by the charging device.

According to an embodiment of the invention, provision is made for the at least one surge arrester to be designed to divert a voltage surge of up to 1.5 kV or of up to 3 kV or of up to 6 kV or of up to 10 kV. As a result, surge protection can advantageously be provided for the on-board power supply system of the electric vehicle.

According to an embodiment of the invention, provision is made for the at least one surge arrester to be designed such that a voltage of less than 1.5 kV is present owing to the diversion of the electric voltage surge when the electric voltage surge appears at the output of the protective device.

According to an embodiment of the invention, provision is made for the surge arrester to be designed as a gas-filled surge arrester or as a gas discharge tube. As a result, if a component-specific ignition voltage is exceeded in the gas discharge tube, it is advantageously possible to ignite a gas discharge and the terminal voltage across the surge arrester is reduced by an arc discharge.

According to an embodiment of the invention, provision is made for the surge arrester to be designed as a varistor. This advantageously allows the surge arrester to absorb large powers within a short response time of under one nanosecond or of under one microsecond without being destroyed.

According to an embodiment of the invention, provision is made for the surge arrester to be designed as a suppressor diode. As a result, a surge arrester which does not cause a voltage breakdown of the voltage to be protected and which therefore is ready to be used again after response even without current interruption can advantageously be provided.

According to an embodiment of the invention, provision is made for the interface device to be designed to be coupled to at least one electrical consumer or to a plurality of electrical consumers of the electric vehicle and to protect the at least one coupled electrical consumer or the coupled electrical consumers against the electric voltage surge. By means of a central surge protection unit downstream of the female charging connector, all of the electrical components which are connected downstream of the central surge protection unit can be dimensioned with the simplest protection requirements.

The described configurations and developments may be combined with one another in any way.

Further possible configurations, developments and implementations of the invention also comprise combinations that are not explicitly cited of features of the present invention described above or below with reference to the exemplary embodiments.

### BRIEF DESCRIPTION OF THE DRAWINGS

The appended drawings are intended to impart further understanding of the embodiments of the invention. They illustrate embodiments and are used to clarify principles and ideas of the invention in conjunction with the description.

Other embodiments and many of the stated advantages emerge with regard to the figures. The illustrated elements of the drawings are not necessarily shown to scale with respect to one another.

In the drawings:

FIG. 1 shows a schematic illustration of a surge protection device for protecting an on-board power supply system of an electric vehicle against an electric voltage surge according to one embodiment of the invention;

FIG. 2 shows a schematic illustration of an electric vehicle having a surge protection device for protecting an on-board power supply system of an electric vehicle against an electric voltage surge according to another embodiment of the invention; and

FIG. 3 shows a schematic illustration of a flow chart of a method for protecting an on-board power supply system of an electric vehicle against an electric voltage surge according to yet another embodiment of the invention.

### DETAILED DESCRIPTION

In the figures of the drawing, identical reference signs denote identical or functionally identical elements, components or method steps unless stated otherwise.

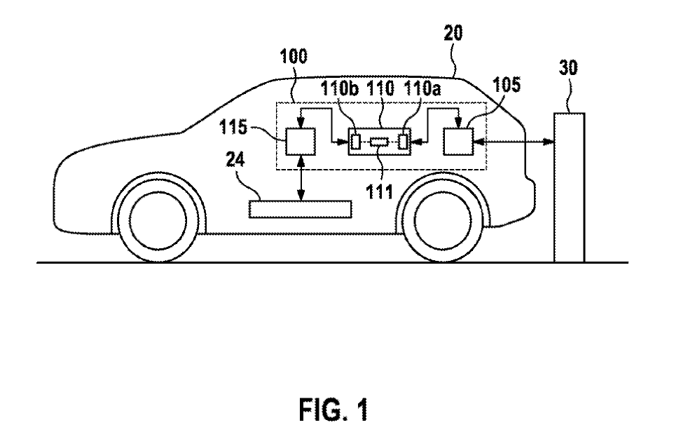

FIG. 1 shows a schematic illustration of a surge protection device for protecting an on-board power supply system of an electric vehicle against an electric voltage surge according to one embodiment of the invention.

A surge protection device 100 for protecting an on-board power supply system 24 of an electric vehicle 20 against an electric voltage surge comprises an input device 105, a protective device 110 and an interface device 115.

Electric voltage surges may be disturbance signals which occur in a power network or in an electrical power grid of a charging device 30, such as lightning strikes, surge pulses or other disturbances that occur when electrical connection couplings fail.

The input device 105 of the surge protection device 100 can be designed as a current connection of the electric vehicle 20. The input device 105 can be designed as a female charging connector or a charging socket for receiving a plug-in connector for charging the electric vehicle 20.

The protective device 110 of the surge protection device 100 can be coupled to the input device 105 at an input 110a of the protective device 110 and have at least one surge arrester 111 for diverting the electric voltage surge.

The interface device 115 of the surge protection device 100, owing to the coupling of an input 110b of the protective device 110 to the on-board power supply system 24, for example, is configured to protect the on-board power supply system 24 of the electric vehicle 20 against the electric voltage surge.

The interface device 115 of the surge protection device 100 can be designed, for example, as a distributor unit, which has a plurality of electrical components, such as warning lights, programmable logic controllers and other automation components and supply sockets, for example.

Furthermore, the input device 105 of the surge protection device 100 can be configured to be coupled to a charging device 30.

In this case, the surge protection device 100 provides a central protective function for all of the electrical components which are coupled to the on-board electrical power supply system 24 of the electric vehicle 20, by the common protection of all of the electrical components using the upstream protective device 110 of the surge protection device 100.

Owing to a central protection unit downstream of the input device 105, all of the electrical components of the on-board power supply system 24 of the electric vehicle 20 downstream of that can be dimensioned with the simplest protection requirements.

Furthermore, the at least one surge arrester 111 of the protective device 110 can be designed to divert a voltage surge of up to 1.5 kV or of up to 3 kV or of up to 6 kV. The diversion can take place via a ground connection of the electric vehicle 20 or via a ground connection of the charging device 30.

By way of example, a voltage of less than 1.5 kV is present owing to the diversion of the electric voltage surge when the electric voltage surge appears at the output 110b of the protective device 110. As a result, simple safety means for surge protection of the individual electrical components can advantageously be used in the on-board electrical power supply system.

By way of example, the surge arrester 111 of the protective device 110 is designed as a gas-filled surge arrester 111 or as a gas discharge tube or as a varistor or as a suppressor diode.

By way of example, components for protecting the inputs and outputs of electronic circuits against temporary voltage surge pulses or voltage transients, as occur as a result of switching processes in the grid or close lightning strikes, are used as suppressor diode, also referred to as transient absorption Zener diode (TAZ diode for short) or transient voltage suppressor diode (TVS diode for short).

By way of example, a gas-filled tube can be used as gas discharge tube, which gas-filled tube is used as surge arrester for protecting against voltage surge pulses; the voltage surge is reduced in the gas discharge tube by the automatic ignition of a gas discharge.

The interface device 115 of the surge protection device 100 can be configured to be coupled to at least one electrical consumer or to a plurality of electrical consumers of the on-board electrical power supply system 24 of the electric vehicle 20 and to protect the at least one coupled electrical consumer or the coupled electrical consumers of the on-board electrical power supply system 24 of the electric vehicle 20 against the electric voltage surge.

The electric vehicle 20 to be protected can be an electric vehicle or a hybrid motor vehicle or another motor vehicle which has an electrical energy store which can be charged during charging of the motor vehicle 20 from a charging device 30 designed as a stationary charging station as charging column.

By way of example, the charging device 30 is a device or an electrical installation which is used to recharge electric vehicles 20 driven by rechargeable batteries by simple insertion or plugging-in of a standard plug into a corresponding socket. The stationary charging device 30 may be configured as part of a charging station.

The stationary charging device 30 comprises, for example, a plug-in connector or a plug which is adapted to a socket or a female connector of the electric vehicle 20.

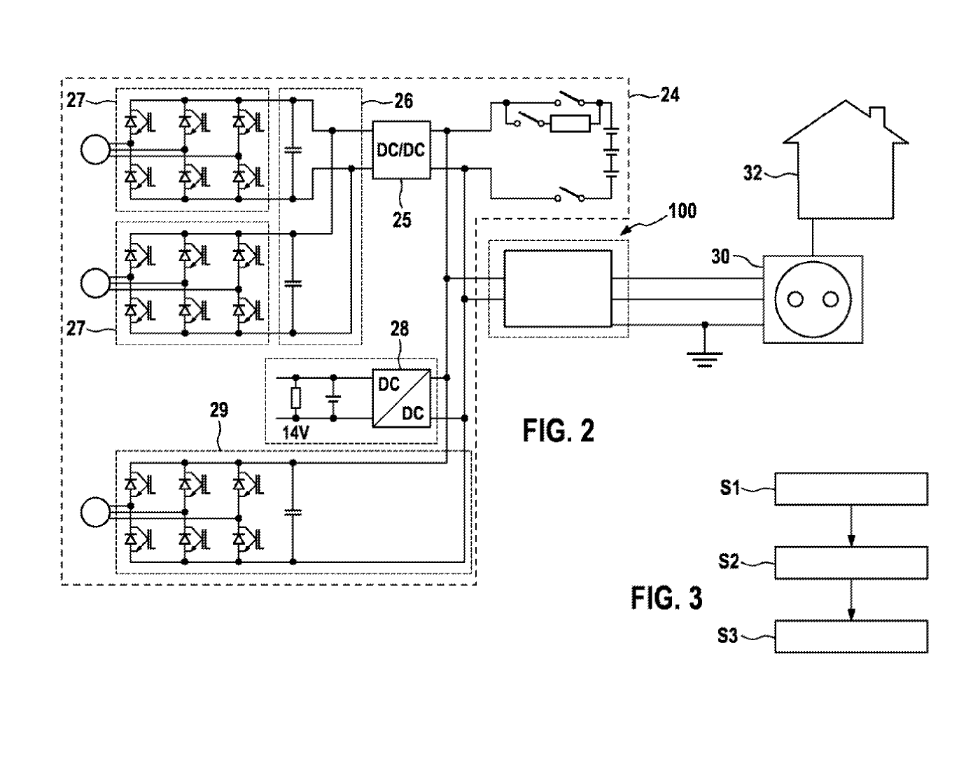

FIG. 2 shows a schematic illustration of an electric vehicle having a surge protection device for protecting an on-board power supply system of an electric vehicle against an electric voltage surge according to another embodiment of the invention.

By way of example, an electric vehicle 20 comprises a surge protection device 100 for protecting an on-board power supply system 24 of an electric vehicle 20. The electric vehicle 20 can be charged by means of a stationary charging device 30 in the form of a charging column.

The charging column can have a socket which is part of a domestic power supply 32. The domestic power supply 32 can have lightning-protection means which allow electrical voltage surges of up to 6 kV. By way of example, an external lightning protector can be connected to the equipotential bonding of the building.

The surge protection device 100 connected upstream can be configured such that the at least one surge arrester 111 of the surge protection device 100 is designed such that a voltage of less than 1.5 kV is present owing to the diversion of the electric voltage surge when the electric voltage surge appears at the output 110b of the protective device 110.

As a result, the electrical components of the electric vehicle 20 are all protected together to a maximum occurring voltage surge of at most 1.5 kV.

The on-board electrical power supply system 24 of the electric vehicle 20 may have, for example, a DC transformer 25, an intermediate circuit 26, electric drive systems 27, a 14-volt on-board power supply system 28 with an integrated DC transformer and an electrical air-conditioning processor circuit 29 as electrical components.

The other reference signs illustrated in FIG. 2 have already been explained in the description of the FIG. 1 and are therefore not described further.

FIG. 3 shows a schematic illustration of a flow chart of a method for protecting an on-board power supply system of an electric vehicle against an electric voltage surge according to another embodiment of the invention.

As a first method step of the method for protecting an on-board power supply system of an electric vehicle, an input device 105 of a surge protection device 100 of the electric vehicle 20 is coupled S1 to a charging device 30 and a protective device 110 of the surge protection device 100 is coupled via an input 110a of the protective device 110 to the input device 105.

As a second method step of the method for protecting an on-board power supply system of an electric vehicle, a surge arrester 111 is provided S2 in the protective device 110 for diverting a voltage surge.

As a third method step of the method for protecting an on-board power supply system of an electric vehicle, the output 110b of the protective device 110 is coupled S3 to the on-board power supply system 24 via an interface device 115 in order to protect the on-board power supply system 24 of the electric vehicle 20 against the electric voltage surge.

In this case, the method steps can be repeated in any sequence, iteratively or recursively.

Although the present invention was described above on the basis of preferred exemplary embodiments, it is not restricted thereto but can be modified in various ways. In particular, the invention can be changed or modified in multifarious ways without deviating from the core of the invention.

1. A surge protection device (100) for protecting an on-board power supply system (24) of an electric vehicle (20) against an electric voltage surge, the surge protection device comprising:
an input device (105), configured as a current connection of the electric vehicle (20);
a protective device (110), coupled to the input device (105) at an input (110a) and including at least one surge arrester (111) for diverting a voltage surge; and
an interface device (115), which, based on the coupling of an output (110b) of the protective device (110) to the on-board power supply system (24), is configured to protect the on-board power supply system (24) of the electric vehicle (20) against electric voltage surges.

2. The surge protection device (100) as claimed in claim 1, characterized in that the input device (105) is configured to be coupled to a charging device (30).

3. The surge protection device (100) as claimed in claim 2, characterized in that the at least one surge arrester (111) is designed to divert a voltage surge of up to 1.5 kV.

4. The surge protection device (100) as claimed in claim 1, characterized in that the at least one surge arrester (111) is designed such that a voltage of less than 1.5 kV is present owing to the diversion of the electric voltage sure when the electric voltage surge appears at the output (110b) of the protective device (110).

5. The surge protection device (100) as claimed in claim 1, characterized in that the surge arrester (111) is a gas-filled surge arrester or as a gas discharge tube.

6. The surge protection device (100) as claimed in claim 1, characterized in that the surge arrester (111) is a varistor.

7. The surge protection device (100) as claimed in claim 1, characterized in that the surge arrester (111) is a suppressor diode.

8. The surge protection device (100) as claimed in claim 1, characterized in that the interface device (115) is coupled to at least one electrical consumer or to a plurality of electrical consumers of the electric vehicle and protects the at least one coupled electrical consumer or the coupled electrical consumers against the electric voltage surge.

9. A method for protecting an on-board power supply system (24) of an electric vehicle (20) against an electric voltage surge, the method having the following method steps:
coupling (S1) an input device (105) of a surge protection device (100) of the electric vehicle (20) to a charging device (30) and coupling a protective device (110) of the surge protection device (100) to the input device (105) via an input (110a) of the protective device (110);
providing (S2) a surge arrester (111) in the protective device (110) for diverting a voltage surge; and
coupling (S3) the output (110b) of the protective device (110) to the on-board power supply system (24) via an interface device (115) in order to protect the on-board power supply system (24) of the electric vehicle (20) against electric voltage surges.

10. An electric vehicle having a surge protection device (100) as claimed in claim 1.

11. The surge protection device (100) as claimed in claim 2, characterized in that the at least one surge arrester (111) is designed to divert a voltage surge of up to 3 kV.

12. The surge protection device (100) as claimed in claim 2, characterized in that the at least one surge arrester (111) is designed to divert a voltage surge of up to 6 kV.
